(19) United States
(12) Patent Application Publication
(10) Pub. No.: US 2011/0071694 A1
(43) Pub. Date: Mar. 24, 2011

(54) SYSTEM AND METHOD FOR MEASURING POWER CONSUMPTION IN A RESIDENTIAL OR COMMERCIAL BUILDING VIA A WALL SOCKET

(76) Inventor: Richard James Mammone, Warren, NJ (US)

(21) Appl. No.: 12/883,550

(22) Filed: Sep. 16, 2010

Related U.S. Application Data
(60) Provisional application No. 61/244,114, filed on Sep. 21, 2009.
(60) Provisional application No. 61/264,162, filed on Nov. 24, 2009.
(60) Provisional application No. 61/357,412, filed on Jun. 22, 2010.

(51) Int. Cl. G06F 1/28; G06Q 30/00

(52) U.S. Cl. 700/291; 700/293; 705/14.49; 705/14.57

(57) ABSTRACT

A system and method to measure power usage within a residence having a plurality of electrical circuits electrically connected to an over-current protection device may include measuring, by a power measurement device electrically connected to one of the electrical circuits by which power loads draw power, an electrical parameter of the electrical circuits. The electrical parameter may be modeled as a lumped complex impedance. Alternatively, the electrical parameter may be a complex impedance of individual appliances. The measurement may be of AC voltages that may be utilized to calculate complex impedance. Alternatively, the measurement may be made using a reflectometer technique used to compute complex impedance. A data value representative of power being drawn by the power loads connected to the electrical circuits using the measured electrical parameter may be computed. An indicia representative of the computed data value representative of the power being drawn on the electrical circuits may be displayed.

### CROSS-REFERENCE TO RELATED APPLICATIONS

This patent application claims priority to U.S. Provisional Patent Application Ser. No. 61/244,114 filed Sep. 21, 2009, U.S. Provisional Patent Application Ser. No. 61/264,162 filed Nov. 24, 2009, and U.S. Provisional Patent Application Ser. No. 61/357,412 filed Jun. 22, 2010; the entire contents of which are herein incorporated by reference in their entireties.

### BACKGROUND OF THE INVENTION

Power usage in homes, offices, and other building structures (residences) are generally used throughout a billing period without a consumer or customer knowing how much the power usage bill will be until a bill from a power company is delivered to the consumer. In many cases, the power or electric bill causes the consumer “sticker shock” due to the power usage being more than anticipated. As consumers and businesses have more electronic devices these days (e.g., large screen televisions, computers, etc.), power usage bills have generally increased over the years and become less predictable.

It has been shown that providing the consumer with real-time or up-to-date (e.g., daily) power usage and/or billing information of power usage that the consumer ends up having a 10% to 20% lower monthly power usage bill. Over the recent past, attempts to provide such information has included using smart meters, power sensors, power meters, and appliance/plug sensors to collect power usage data and provide the consumer with real-time or up-to-date power usage information.

Smart meters are power meters that have “intelligence” built in (e.g., processing system) to be able to collect and communicate power usage data of power used within a residence. Smart meters have been replacing traditional “dumb” power meters that have electromechanic dials, including a large disk, that rotate as power is being consumed. The smart meters enable the power company to read power usage remotely, and may also be used to provide the consumer with real-time or up-to-date power usage information. The smart meters are expensive and require an electrician to install, which further increases the cost.

Power sensors are electronic devices that are typically installed at existing traditional power meters, circuit breakers, or fuse boxes. The power sensors are generally installed directly on high-voltage lines that enter or exit the power meter, circuit breaker, or fuse box. Some power sensors use magnetic sensors that sense magnetic fields generated by the power lines. Power sensors can be expensive because of the electrical components used to produce the power sensors, but are also expensive to install due to an electrician having to perform the installation onto high-voltage lines or within a glass cover of the power meter.

Meter readers generally utilize optical reading devices that are capable of sensing a stripe on a power meter disk that rotates as the power meter senses power usage. The meter reader counts rotations of the stripe and uses the count to calculate the amount of power used by the consumer. The meter reader may be strapped around the glass of the power meter by the consumer. The meter reader generally costs over $100 and requires a basic level of mechanical skill for a consumer to install.

Appliance/plug sensors are devices that are configured to be plugged into a wall socket and have an appliance plugged into the appliance/plug sensor. The appliance/plug sensor is capable of measuring power consumed by the appliance connected thereto and communicate the measured power to a central location, generally local to the appliance/plug sensor (i.e., at the residence). The appliance/plug sensor typically costs about 100. While the appliance/plug sensor requires virtually no skills to install, in order to measure total power consumed in a residence, several thousands of dollars of appliance/plug sensors are required to be purchased so that each appliance may be independently measured.

While the above-described techniques for measuring power in a residence are available and useful to allow a consumer to monitor power usage, each has a shortcoming whether it be cost or consumer installation requirements.

### SUMMARY OF THE INVENTION

To overcome the shortcomings of existing power sensing systems and devices, the principles of the present inventive concept provide for a socket meter capable of measuring resistance and/or complex impedance of devices throughout a residential network or other network and determine total power usage. Residence power lines are generally configured to include two circuits or phases that are separated by capacitance at a fuse box or circuit breaker. The socket meter may generate a high-frequency (HF) signal that is communicated onto a power line connected to the wall socket, where the HF signal may cross over the capacitance at the fuse box or circuit breaker as a result of being a high enough frequency so that impedance of appliances on both power circuits can be measured. The socket meter may use coherent or non-coherent measurement techniques. Alternatively, the socket meter may be configured to use reflectometer techniques, using coherent or non-coherent techniques, to measure complex impedance of the appliances on the circuit. In one embodiment, time domain power usage measurements may be made and those measurements may be compared with a power usage “signature” of different appliances to determine type of appliance, make, and possibly model.

In addition to users being able to easily measure power usage, the principles of the present inventive concept provide for a service provider to monitor various parameters of appliances being utilized by a consumer and provide the consumer with information specifically tailored to the residence of the consumer. As described above, complex impedance measurements may be made of appliances connected to electrical outlets in a residence of the consumer by using reflectometer techniques. A real part (resistance) of the complex impedance of an appliance may be monitored over time, which enables the service provider to track the appliance as it becomes less efficient over time. As with the time domain power usage measurements, the service provider may determine a type of appliance being measured, and possibly make and model, based on the complex impedance characteristics of the appliance. And, as the efficiency of the appliance deteriorates as represented by the resistance (real part of complex impedance) increasing, the service provider may generate an ad for the consumer with potential replacement appliances from one or more sellers, thereby anticipating the consumer's purchasing needs. In one embodiment, the sellers of the potential replacement appliances may be geographically local to the consumer. In addition, the service provider may track rate of resistance increase as power is applied to the appliance and, if the rate of resistance increases too fast, which may be indicative of the appliance becoming dangerously hot, then the service provider may notify the consumer of a potential fire hazard. Still yet, the principles of the present inventive concept may provide for generating a map of the consumer's residence and illustrating real-time, up-to-date, and non-real-time power usage of the appliances.

The service provider may collect aggregate data of the appliances and provide the data to manufacturers of the appliances, industry players, and consumers. In one embodiment, the principles of the present inventive concept may track geothermal conditions as well as wind and solar energy for the location as produced by governmental and non-governmental groups, and, based on power usage data collected from the residence of the consumer, determine whether other power sources (e.g., solar panels or wind turbines) would benefit the consumer. The consumer may be provided with a cost/benefit analysis along with advertisement(s) from service providers of the alternative power sources.

One embodiment of a method for measuring power usage within a residence having a plurality of electrical circuits electrically connected to an over-current protection device may include measuring, by a power measurement device electrically connected to one of the electrical circuits by which power loads draw power, an electrical parameter of the electrical circuits. The electrical parameter may be a lumped complex impedance. Alternatively, the electrical parameter may be a complex impedance of individual appliances. The measurement may be of AC voltages that may be utilized to calculate complex impedance. Alternatively, the measurement may be made using a reflectometer technique used to compute complex impedance. A data value representative of power being drawn by the power loads connected to the electrical circuits using the measured electrical parameter may be computed. The data value may be instantaneous power usage based on the measured electrical parameter. An indicia representative of the computed data value representative of the power being drawn on the electrical circuits may be displayed. The display of the indicia may be on a website available for a customer to download and view with a computer or other device that offers internet access. Alternatively, the display may be on a socket meter connected to a socket in a residence that connects to one of multiple power circuits at the residence. The method may include measuring across the phases of a power network via a phase coupler or wireless communication device to transfer readings across the phases so as to enable measurement of lower frequencies (e.g., at or below 1 MHz). The phase coupler may include a high precision impedance converter system having a frequency generator with an analog-to-digital converter, such AD5934 provided by Analog Devices Inc, which includes a 12-Bit, 250 kSPS analog-to-digital converter (ADC) as detailed in the AD5934 Data Sheet. Rev. A, which is incorporated herein by reference in its entirety.

One embodiment of a device for measuring power usage within a residential or commercial building having a plurality of electrical circuits electrically connected to an over-current protection device may include a first circuit configured to generate an alternating current (AC) measurement signal, a second circuit configured to apply the AC measurement signal onto one of the electrical circuits, and a third circuit configured to measure a plurality of AC voltages in response to said second circuit applying the AC measurement signal onto one of the electrical circuits. A processing unit may be in communication with the third circuit, and configured to calculate an impedance of appliances connected to the electrical circuits. The impedance may be a lumped impedance as calculated by the impedances being connected in parallel with one another. An input/output unit may be in communication with the processing unit, and configured to communicate data generated by the processing unit to a remote location via a communications network. The socket device may have an embedded web server which runs a local web site that stores data that has been measured locally and performs calculations of indices derived from the measurement data which can be distributed in addition to the measured data. This web site can be accessed remotely in various ways. The remote access location may be a server configured to collect and process the generated data on a public web site.

One embodiment of method of advertising electrical appliances to potential customers may include monitoring electrical resistance of an electrical appliance over time. A determination that a projected cost for utilizing the electrical appliance over a projected time period based on the monitored electrical resistance will exceed a projected cost for utilizing a replacement electrical appliance over the projected time period may be made and a notice that indicates that a user of the electrical appliance will save money by replacing the electrical appliance with the replacement electrical appliance over the projected time period may be generated. The notice may further include a listing of the replacement electrical appliance available for purchase. The listing may include one or more advertisements. The advertisements may be from local advertisers, such as retailers, that sell electrical appliances. The notice may be communicated to the user, as a potential customer of a more energy efficient appliance which can replace their current appliance which shows inefficient use of energy as compared to aggregate data accumulated at the remote site.

### BRIEF DESCRIPTION OF THE DRAWINGS

Illustrative embodiments of the present inventive concept are described in detail below with reference to the attached drawing figures, which are incorporated by reference herein and wherein:

FIG. 1 is an illustration of an illustrative multi-phase power circuit network within a residence;

FIG. 2 is a block diagram of a socket meter connected to a wall socket that is electrically connected to a power circuit of a power circuit network within a residence;

FIG. 3 is an illustration of an illustrative bus impedance as a function of paralleled poly-phase power lines;

FIG. 4 is an illustration of an illustrative linear AC RMS voltmeter circuit;

FIG. 5 is an illustration of an illustrative load impedance circuit schematic; and

FIG. 6 is an illustration of a real and imaginary complex impedance and voltage vectors used to calculate reactance;

FIG. 7 is a graph of an illustrative power signal representative of power drawn by appliances connected to power circuits in a residence;

FIG. 8 is a block diagram of an illustrative socket meter;

FIG. 9 is an illustration of an illustrative network system including an illustrative socket meter connected to a power circuit that connects to a breaker panel of a residence;

FIG. 10 is a flow chart of an illustrative process for measuring and processing electrical parameters of electrical circuits to determine power usage;

FIG. 11A is a block diagram of an illustrative network illustrating a service provider that is servicing customers at residences;

FIG. 11B is a block diagram of an illustrative set of software modules that may be executed on the processing unit of FIG. 11A of the service provider server;

FIG. 12 is a flow diagram of an illustrative process for monitoring power usage by measuring resistance of appliances at a residence and communicating a notice to the customer;

FIG. 13 is a screen shot of an illustrative browser interface that illustrates an illustrative website that enables a customer of a service provider to submit preferences for the service provider to provide advertisements to the customer;

FIG. 14 is a screenshot of an illustrative browser interface that includes an illustrative webpage including power usage information, messages/warnings, and advertisements for a customer to view; and

FIG. 15 is a screenshot of an illustrative browser interface that includes an illustrative webpage including power usage information, geothermal availability, messages/warnings, and advertisements for a customer to view.

### DETAILED DESCRIPTION OF THE PREFERRED EMBODIMENTS

Reference will now be made in detail to the embodiments of the present inventive concept, examples of which are illustrated in the accompanying drawings, wherein like reference numerals refer to the like elements throughout. The embodiments are described below in order to explain the present inventive concept by referring to the figures.

Determining power usage of a residence, which includes commercial and residential premises, is desirable for a variety of reasons by a variety of parties. For example, consumers who pay for energy usage have a desire to track energy usage between bills to avoid “sticker shock” when receiving a power bill from an energy service provider. Consumers who want additional fire prevention services may find the principles of the present inventive concept desirable. Consumers who desire to know if an appliance is becoming inefficient may also have an interest. In addition, service providers that desire to have additional communications with consumers may have an interest. Still yet, advertisers of appliances who desire to reach out to consumers in anticipation of the consumer having to replace an existing appliance due to becoming energy inefficient or broken may have an interest. While the above reasons for the various parties to determine power usage, cost and consumer-friendliness of devices capable of measuring power usage in a residence have been problematic.

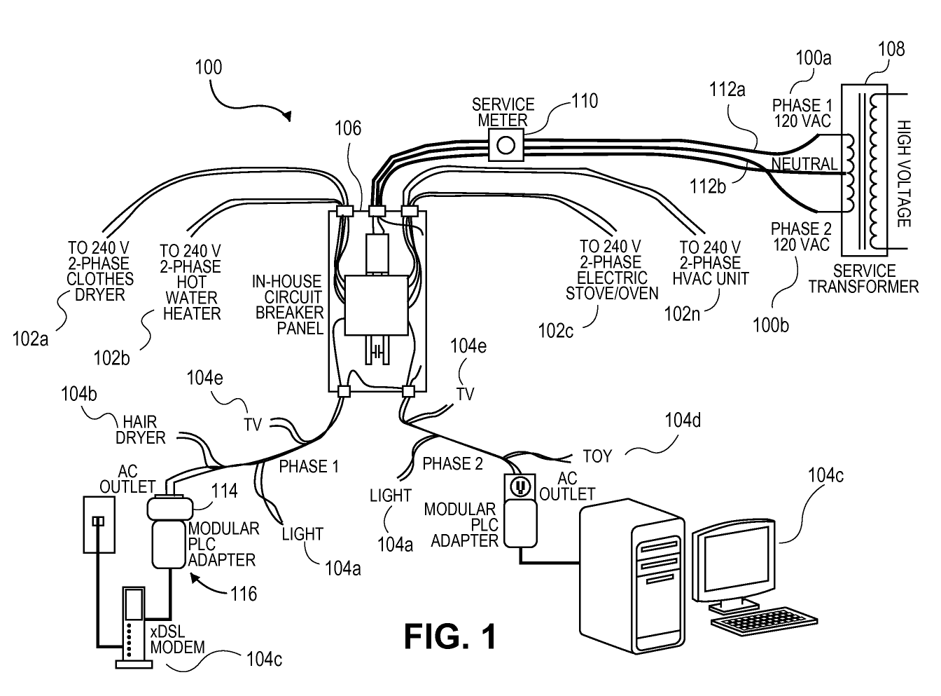

FIG. 1 is an illustration of an illustrative power circuit network 100 used in a residence (e.g., house) to power appliances 102a-102n (collectively 102). The appliances 102 may include a clothes dryer 102a, hot water heater 102b, electric oven/stove 102c, and HVAC unit 102n. Other appliances, such as lights 104a, hair dryers 104b, computers 104c, toys 104d, televisions 104e, and any other electrical devices (collectively 104) plugged into the power circuit and are also contemplated for measurement in accordance with the principles of the present inventive concept.

As illustrated, and as understood in the art, the power circuit network 100 includes two phases or circuits 100a and 100b that extend from an over-current protection device, such as a circuit breaker 106. As further understood in the art, a service transformer 108 external from a residence delivers a two-phase 240 volt AC power signal to the residence (not illustrated). Between the service transformer 108 and circuit breaker 106, a service meter 110 is illustrated to be connected to two power lines 112a and 112b from the service transformer 108. The service meter 110 measures overall power drawn from the appliances 102. The service meter 110 is generally a “dumb” service meter that merely measures power usage and has no communication or intelligence capabilities. Smart service meters that have been deployed in recent years have communication ability to report back power usage, but are expensive and have limited capabilities as compared to the principles of the present inventive concept. It should be understood that the availability of a smart meter on a power circuit network at a residence does not preclude the use of a socket meter as described herein or utilization of the principles of the present inventive concept. In fact, certain aspects of the principles of the present inventive concept could be incorporated into a smart meter.

Within the circuit breaker 106 is a capacitance C formed by bus bars with each poly-phase line and conductor. As understood in the art, the capacitance isolates the two phases and prevents DC and low frequency signals from passing between the two circuits 100a and 100b. As a result of the capacitance C, conventional power measurements, such as current measurements using an ammeter, are prevented from being made.

As conventional power measurements cannot be made, the principles of the present inventive concept utilize high frequency signals or tones that are capable of passing through the capacitance C and measuring a resistance and/or an equivalent complex impedance of all the appliances on the two circuits 100a and 100b. The equivalent complex impedance may be used to calculate instantaneous power usage, as further described herein. The high frequency signal may be generated by a socket meter 114 utilizing high frequency (HF) chips that are available for power line communications (PLC). HF chips generally operate between 1 MHz and 30 MHz, which is suitable for the high frequency signal. However, it is generally understood that frequencies about 1 MHz and higher are able to pass through capacitance C and may be used to make the complex impedance measurements with no additional devices needed to measure across the two phases. The present inventive concept measures the total impedance and line voltage to calculate the power usage. The total impedance across both phases can be measured at HF or measured on each phase separately and combined in a central computer. The total impedance can be measured remotely via steady state AC measurements. In an alternative embodiment, rather than measuring an equivalent resistance and/or complex impedance by steady state AC measurements, reflectometer measurement techniques may be utilized to measure impedance characteristics of each appliance on the power line network 100 on an individual basis. The socket meter 114 may be configured to be plugged into a signal socket 116 on one of the power circuits, such as power circuit 100a, and measure resistance and/or complex impedance for calculating power usage by the appliances on both circuits 100a and 100b if the pulses used are modulated to frequencies above 1 MHz.

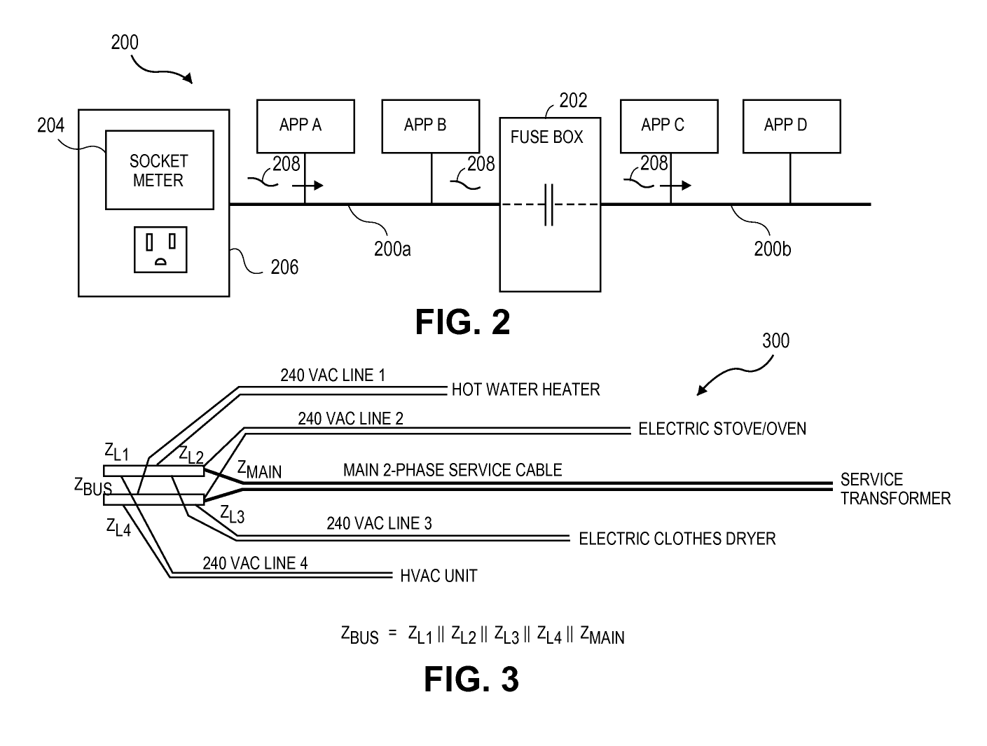

With regard to FIG. 2, an illustrative simplified power circuit 200 is illustrated. The power circuit 200 is composed of two circuits 200a and 200b on different sides of fuse box 202. Appliances (Apps) A and B are connected to power circuit 200a and appliances C and D are connected to power circuit 200b. The power circuits 200a and 200b are electrically separated by capacitance C at DC and low frequencies (below approximately 1 MHz). A socket meter 204 is illustrated to be connected to power socket 206. The power socket 206 may be a conventional power socket that includes two outlets. The socket meter 204 may be configured with either a two or three prong plug to be inserted into the power socket 206 to connect to power circuit 200a.

The socket meter 204 may be configured to convert to 120V AC power from the power socket 206 into a low voltage, high frequency signal 208. The low voltage may be 5V, for example. Other voltages may alternatively be utilized. However, to maintain a low production cost, the use of voltages that comply with standard chip sets (e.g., HF chips) may be utilized. Of course, custom circuitry may alternatively be utilized.

With regard to FIG. 3, an illustration of a representative impedance circuit model 300 of impedances on a power circuit in a residence is illustrated. The impedance circuit model 300 illustrates how lumped impedance Zbus is determined as a function of an impedance of each appliance connected to the power circuit and being electrically connected in parallel with one another.

Zbus=Z_{L1}∥Z_{L2}∥Z_{L3}∥Z_{L4}∥ZMain (1)

From the bus impedance, total power being used by the residence may be computed. The total power may be computed by using the real part of Zbus, which is resistance Rbus, and an actual measured voltage across the socket

As the actual voltage may not be 120V due to variations of loading and other effects, an actual voltage measurement is made. The calculation of total power includes doubling the measured voltage to account for the two phases or power circuits. As understood in the art, power may be calculated as P=V²/R, so in the case of determining total power across the two power circuits in a residence, power is computed by:

Ptotal=(Vsocket)²/R_{bus} (2)

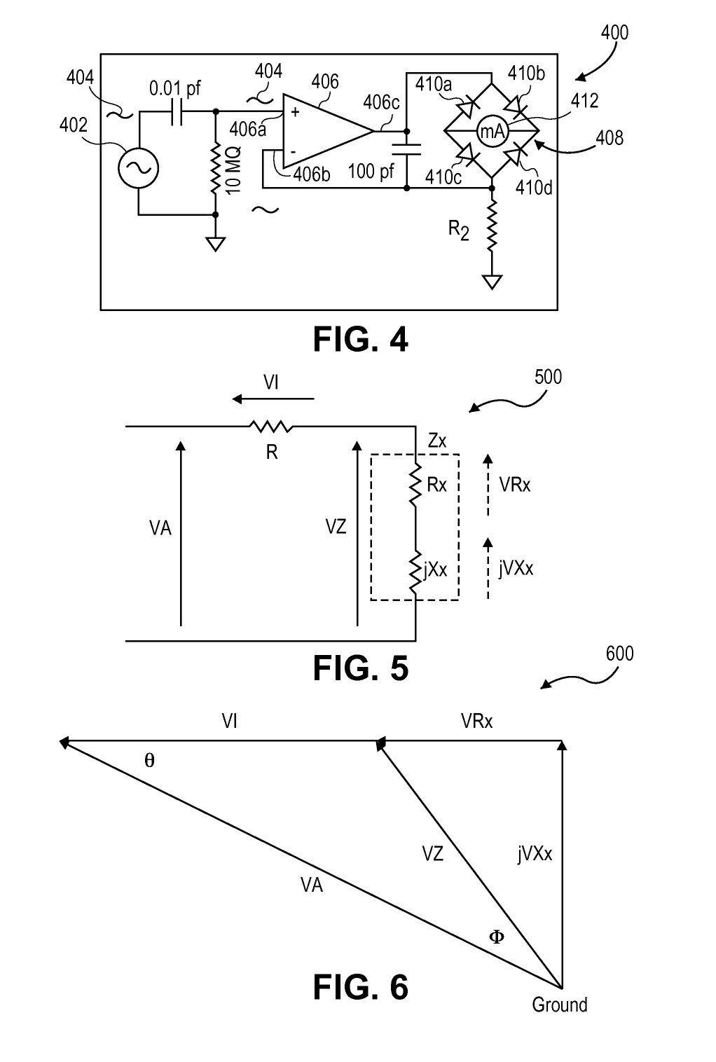

With regard to FIG. 4, an illustrative linear AC voltmeter 400 is illustrated. The AC RMS voltmeter circuit may be used to convert AC voltage into RMS voltage values. It should be understood that the AC voltmeter circuit is illustrative and that alternative AC voltmeter circuits may be utilized.

The AC voltmeter 400 includes a high-frequency voltage source 402 that generates a source signal 404 that is input into a positive terminal 406a of op amp 406. A rectifier 408 includes four diodes 410a 410b, 410c, and 410d. Current flows in or out of the output 406c of the op amp 406, through one of the top diodes 410a or 410b, through meter 412 from right to left, through one of the bottom diodes 410c or 410d, and up or down through resistor R to match the source signal 404. Because the meter 412 and resister R are in series, the same current flows across resistor R as the meter 412, and, as understood in the art, the op amp 406 forces the output voltage at output terminal 406c to make the inverting input voltage let input terminal 406b to the same as the input voltage (source signal 404) on the positive input terminal 406a. The current meter 412 may be calibrated to indicate RMS of a sine wave. In addition, the value of resistor R sets the full range of the meter 412. If a 1 mA meter is used, a 1 volt range is provided. The 100 pF capacitor prevents the op amp 406 to oscillate at high frequencies. However, since the 100 pF capacitor causes accuracy to be lost at high frequencies, this capacitor should be as small as possible while still preventing oscillations. It should be understood that alternative values and configurations may be utilized to provide for the same or equivalent functionality in accordance with the principles of the present inventive concept.

The voltmeter 400 provides for measuring AC RMS voltage in a time domain. The voltmeter 400 may be configured to measure each of the AC voltages, VA, VI, and VZ illustrated in FIG. 5. The voltage Vsocket which is nominally 60 cycle per second 120 volt voltage across the outlet is also measure by RMS. In addition to the three voltages VA, VI, and VZ that are monitored by the voltmeter circuit. These voltages are used to calculate the complex impedance, power, and the complex power (i.e., real and reactance power).

With regard to FIG. 5, a schematic illustrative load impedance circuit 500 is illustrated. The load impedance circuit 500 includes a resistance R at a voltage source and an unknown complex impedance Zx. For RF measurements, the resistance R is typically set to 50 ohms. The unknown complex impedance Zx is composed of a real part (resistance Rx) and an imaginary part (reactance jXx), and is representative of parallel complex impedances as would be positioned on a power circuit, as described in FIG. 3. Complex impedance may be measured by having a known resistance and three AC voltage measurements, in this case VA (applied voltage), VI (voltage across known resistor), and VZ (voltage across unknown impedance). FIG. 6 is an illustration of the real and imaginary complex impedance that may be used to calculate reactance (i.e., capacitance and inductance). Although only magnitudes of the voltages are known, vectors, as illustrated in FIG. 6, may be represented for use in computing the unknown complex impedance values. The law of cosines may be used to calculate the value of angle θ.

$$cos ( θ ) = \frac{V {A}^{2} + {VI}^{2} - {VZ}^{2}}{2 * V A * VI} \qquad ( 3 )$$

From the load impedance circuit 500, the magnitude of the total impedance including R may be calculated as:

Za=R*VA/VI (4)

where VA is the source voltage and VI is the voltage across the resistor R.
The sum of R and Rx can be found by:

R+Rx=Za*Cos(θ) (5)

where θ is illustrated in FIG. 6.
Rx may then be solved for by:

Rx=Za*Cos(θ)−R (6)

Considering possible measurement errors, it is possible that Rx could be computed to be negative, even though unlikely in practice. If such a result does occur, then Rx may be set to zero as the impedance is purely reactive.

The magnitude of the unknown impedance may be calculated as:

Z=R*VZ/VI (7)

The magnitude of the unknown reactance may be calculated as:

Xx=sqrt(Z²−Rx²) (8)

Considering possible measurement errors, it is possible that the square root of a negative number may occur. If such a result occurs, then Xx may be set to zero. The unknown reactance may be used for recognition of a type, make, and model (optional) of an appliance and not necessarily for use in calculating power usage.

As an example of using the above equation to compute the unknown complex impedance, the unknown complex impedance may include a 30 ohm resistor in series with a 60 ohm reactance, which combine to form a 67 ohm complex impedance. If the measurement resistor R is 50 ohms and the applied voltage VA is 1V RMS, the measured voltage VI is 0.5 Vrms and the measured voltage VZ, is 0.67 Vrms. The cosine of theta computes to be 0.8. The unknown impedance Zx computes to be 67 ohms, where Rx computes to be 30 ohms, and jXx computes to be j60 ohms. The AC voltmeter may be used to measure the applied AC voltage VA and measured AC voltages VI and VZ. Alternatively, peak-to-peak values or true RMS values could used. It should be understood that magnitude and phase measurements are not necessary for each voltage measurement, which would be more complex and expensive.

In addition to calculating the total power Ptotal (equation (2)), total hub reactance Zhub may be calculated to be used to compute power usage on the power circuit network, where Zhub is calculated by:

Zhub=Rhub+jXhub (9)

The total power Ptotal and total reactance Zhub may be calculated on a regular basis, such as every second, to compute power usage on the power circuit network.

While using high frequency signals allows for measuring impedance (i.e., resistance and reactance) of appliances on multiple power circuits, the use of high frequencies introduces additional complexities in the measurement process. Resistance of wires increases with frequency due to “skin” effect. As an example, resistance of wire at 60 Hz may be close to 1 ohm. However, at 1 MHz, the resistance of the wire at 1 MHz may be significantly higher. Additional resistance of the wire is seen at higher frequencies. As the resistance of the appliances being measured may be in the tens of ohms, skin effect of the wire may make measurement difficult. Skin effect, as understood in the art, causes AC current to flow on the outside of wires. Since the inside of the wires are not used for conducting current, when calculating resistance, as much of the middle of the wires may be eliminated. For copper at 70 C, skin depth in mils is calculated as:

S=2837/sqrt(f) (10)

where f is frequency in Hertz.

The decrease in area of the current flow increases the resistance Rhf over that of the DC resistance of the wires. The relationship of the resistance is proportional to the square root of the frequency and a constant value that depends on the type and combination of types of wire used in the premises when the skin depth squared is much less than the radius of the wire used as in the case of most residential wiring operating in the range of 1 to 30 Mhz. Therelationship is given as:

Rhfwire=Rdcwire×Kwire×sqrt(f)=Khftotal×sqrt(f) (11)

The skin effect resistance problem may be substantially eliminated by performing measurement at two or more different frequencies over the HF frequency range, for example. The two or more measurements are used to form a model of the form:

$$\begin{matrix}Rhf 1 = Rapp + Rwire \times Kwire \times sqrt ( f 1 ) & ( 11 a ) \\ Rhf 2 = Rapp + Rwire \times Kwire \times sqrt ( f 2 ) & ( 11 b ) \\ Rhf 3 = Rapp + Rwire \times Kwire \times sqrt ( f 3 ) \\ ⋮ & ( 11 c ) \\ Rhfn = Rapp + Rwire \times Kwire \times sqrt ( fn ) & ( 11 n )\end{matrix}$$

In one embodiment, a least squares function may be utilized to determine Rapp and Ktotal. Since the power dissipated by the wires is negligible, only the resistance of the appliance Rapp may be retained for further consideration. The skin effect also reduces inductance of the wire, but only by a few percent, which is generally negligible relative to the actual loads. However, this effect could also be corrected in a similar manner to that used for the resistance in certain cases.

The least squares solution for Rx=R0+R1*sqrt(f) may be generalized to many loads that are modeled as a parallel combination of resistor pairs of Ri+Ri+1 sqrt(f). The resistor pairs may be combined using the parallel rule for resistors to form a nonlinear function of resistors and the measurement frequency. The series of nonlinear equations may be solved using well-known methods, such as nonlinear least squares to find the resistor values for each appliance and each length of wire between the appliances. The resulting information can be used to plot a map of power usage within a residence.

The calculations for Rx may be made using linear algebra for each of the frequencies, as provided below:

$$\begin{matrix}[ \begin{matrix}Rx ( 2 ) \\ Rx ( 4 ) \\ Rx ( 6 ) \\ Rx ( 8 ) \\ Rx ( 10 )\end{matrix} ] = [ \begin{matrix}1 & \sqrt{2 \times {10}^{6}} \\ 1 & \sqrt{4 \times {10}^{6}} \\ 1 & \sqrt{6 \times {10}^{6}} \\ 1 & \sqrt{8 \times {10}^{6}} \\ 1 & \sqrt{10 \times {10}^{6}}\end{matrix} ] [ \begin{matrix}{R}_{0} \\ {R}_{1}\end{matrix} ] & ( 12 ) \\ r = XR & ( 13 ) \\ R = {[ {X}^{T} X ]}^{- 1} {X}^{T} r = [ \begin{matrix}{R}_{0} \\ {R}_{1}\end{matrix} ] & ( 14 )\end{matrix}$$

where R₀ is the dc resistance of the load. By measuring complex impedance over multiple frequencies, the portion of the impedance that changes at different frequencies may be determined to be associated with the wires that form the power circuit and be removed from the power usage calculations.

The dc resistance R_{dc} may be used to calculate the power used by all the appliances of the residence, where

power=P=(Vrms socket)²/Rdc

Equation (17) may be used for a socket meter that is plugged into a wall socket that is delivering 120 V AC from one of the phases or circuits of the power circuit network within a residence. If, however, the socket meter or other measurement device in accordance with the principles of the present inventive concept is plugged into a 240 V AC receptacle, then it is noted that the socket device bridges both phases and can use low frequency signals and the voltage will be nominally 240 volts rms rather the the 120 volts rms encountered on the single phase more common 120 volt rms socket device.

The volt amperes reactance may be calculated:

Q=(Vrms socket)²/Xx (16)

where the complex impedance is completed by:

Z=R0+jXx

Xx may be measured at a number of frequencies in the HF band and extrapolated down to 60 Hz by finding Xx as a polynomial function of frequency using a least square function in a manner similar to that used to separate out the skin effect. The polynomial model may be justified based on the series expansion of the actual rational function (ratio of polynomials). Volt-ampere reactive (VARs) while not used in residential energy usage, is used for determining energy costs for some commercial customers. Hence, determining complex impedance and VAR power may be provided by the present inventive concept for commercial customer purposes.

As an example of measurements and calculations made using the techniques described above, TABLE I illustrates an illustrative set of measurements and calculations of measured voltages and calculated resistances and complex impedances.

TABLE I
AC Voltage and Impedance Measurements

| f (MHz) | VA | VI | VZ | VA² | VI² | VZ² | Cos | Za | Rx | Z | Xx |
|---|---|---|---|---|---|---|---|---|---|---|---|
| 1 | .411 | .294 | .117 | .168921 | .086436 | .013689 | 1 | 71.29592 | 20.29592 | 20.29592 | 7.91e−7 |
| 2 | .401 | .287 | .114 | .160801 | .082369 | .012996 | 1 | 71.25784 | 20.25784 | 20.25784 | 6.31e−7 |
| . . . | . . . | . . . | . . . | . . . | . . . | . . . | . . . | . . . | . . . | . . . | . . . |
| 6 | .335 | .24 | .095 | .112225 | .0576 | .009025 | 1 | 71.1875 | 20.1875 | 20.1875 | 0 |

FIGS. 3-6 and descriptions related thereto provide for a non-coherent technique for determining lump impedance (i.e., each of the appliances in parallel) for calculating power usage in a residence. As an alternative to using the non-coherent technique described above, the principles of the present inventive concept provide for a coherent method, as well. The coherent method may utilize mixers to down-convert the high frequency signal to baseband signals. Such coherent processing techniques of high frequency signals are known in the art. Coherent processing generally costs more money than non-coherent techniques due to more expensive and additional circuitry. One skilled in the art could readily create a circuit to perform coherent measurements may be used to compute impedance and resistance, as described above. The method described here in detail is one method known in the art to measure complex impedance. There are several other known methods that could be used in the present inventive concept for this purpose such as an auto balancing bridge impedance meter circuit, a resonant Q-Meter, RF I-V (radio frequency current-voltage) impedance measurement circuit, Network Analysis (Reflection Coefficient) or TDR (Time Domain Reflectometry) circuits. Any of these techniques can be used to measure complex impedance in the HF frequency range of 1-30 Mhz as used by the present inventive concept.

The measured complex impedance can then be distinguished from each other or “decomposed” into separate components which represent the individual impedances of the appliances which load the network. The network and individual complex impedances are then converted into the network and individual appliance complex power values for the whole building (e.g., an entire residence's network) as well as each appliance individually. For example, one appliance or all appliances in a single network may be monitored using the present inventive concept.

The principles of the present inventive concept provide for performing impedance measurements which can be made using time domain reflectometer (TDR) techniques. To have a reflectometer pulse pass through capacitance at the breaker circuit, the reflectometer pulse may be multiplied or modulated by a high frequency carrier signal above 1 MHz (e.g., between 1 MHz and 30 MHz). Return or reflected pulses from appliances and discontinuities may be demodulated and measured to determine complex impedances. Alternatively, the impedance can measured on each phase using frequencies below 1 MHz and combined in the processor unit using wireless communications or a phase coupler. As with the lump parameter impedance techniques, the reflectometer techniques may utilize non-coherent and coherent measurement techniques, as understood in the art. Reflectometer measurement techniques have an advantage over lump impedance measurement techniques in that the reflectometer technique measures reflections of the reflectometer signal, which means that skin effect of the wire of the power circuit network does not impact the measurements, thereby eliminating having to take measurements at multiple HF frequencies and post processing to eliminate skin effect wire measurements. While the negative impact of skin effect is avoided by using reflectometer techniques to determine impedance and calculate power usage, reflectometer techniques are more difficult and expensive to implement due to rise time of electronics in order to measure reflected signals that are traveling at approximately half the speed of light. However, if produced in bulk, the costs may be reduced on a per unit basis such that the higher, yet economical costs may be worth the improved measurement accuracy over the lump impedance technique.

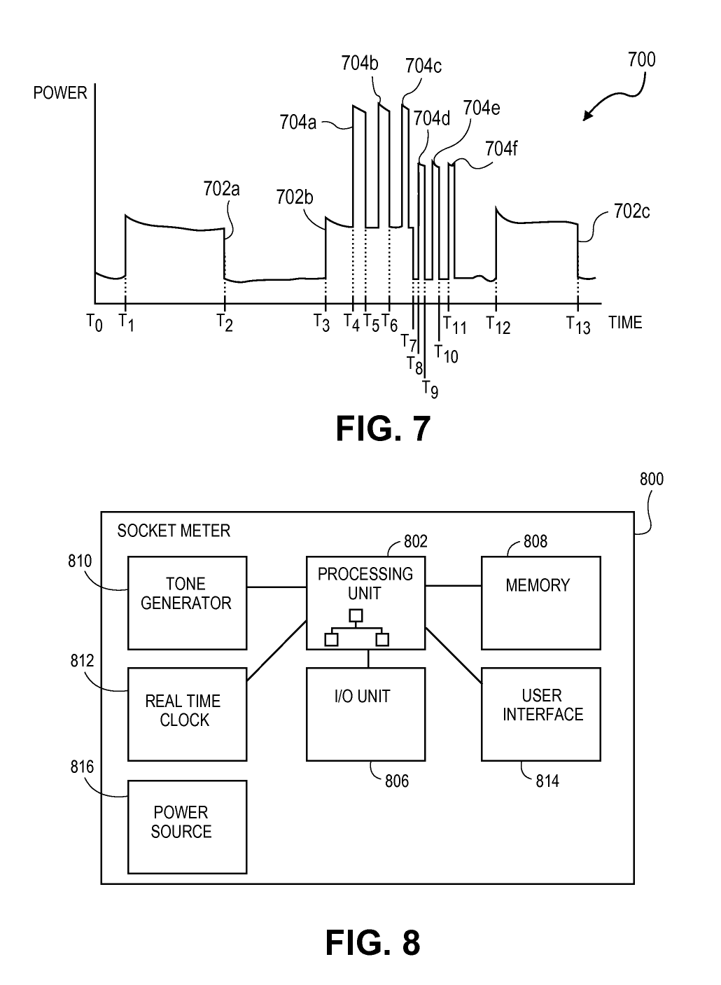

With regard to FIG. 7, a graph of an illustrative power signal 700 representative of power drawn by appliances connected to power circuits in a residence is illustrated. As illustrated, three refrigerator cycles 702a-702c (collectively 702) are illustrated as creating a “square” in the power signal 700 in response to a refrigerator turning on and off. In addition, six heater cycles 704a-704f (collectively 704) in response to a heater turning on and off. Each of the refrigerator and heater cycles 702 and 704 provide a signature for power usage of an associated appliance. It should be understood that the refrigerator and heater cycles 702 and 704 are illustrative and that alternative cycles may be generated depending on appliance, make, and model. In one embodiment, signature signals or curves of cycles of each type, make, and model of appliance may be stored locally on the socket meter or remotely on a server. The stored signature signals may be compared against the measured cycles, thereby enabling determination of the specific type, make, and model of the appliance. As illustrated between times t₃ and t₇, a refrigerator cycle 702b is illustrated to occur along with heater cycles 704a-704c. When the heater cycles 704a-704c occur, the amount of power drawn on the power circuits increases, such that the power usage extends from a top level of heater cycle 702b. In determining which cycles are occurring to determine what appliances are turning on and off and how much power each is drawing, a matching algorithm that is capable of separating and identifying particular cycles in the power signal 700.

With regard to FIG. 8, a block diagram of an illustrative socket meter 800 is illustrated to include a processing unit 802 that executes software 804. The processing unit may be in communication with an input/output (I/O) unit 806, memory 808, tone generator 810, real time clock 812, and user interface 814. The I/O unit 806 may be configured to communicate (i) measurement signals over power lines within a residence and (ii) data communication signals over a communications network, such as a mobile telephone network, Wi-Fi network, the Internet, or any other communications network, as understood in the art. Although not illustrated, it should be understood that the I/O unit 806 may be configured with both analog-to-digital and digital-to-analog circuits to allow for conversion of analog to digital and digital to analog signals, as understood in the art. The memory 808 may be configured to store software and data that is being collected and processed by the socket meter 800. The memory 808 may further be configured to store signature data of appliances to enable the socket meter 800 to be able to determine what specific appliances are operating on the power circuit in the residence in which the socket meter 800 is operating. Alternatively, data that is collected and communicated to a server may be used in determining what specific appliances are operating on the power network in the residence at the server remote from the socket meter 800.

Tone generator 810 may be configured to generate one or more tones above approximately 1 MHz to enable the tones (i.e., signals) to be communicated over the power lines in the residence and through capacitance at a circuit breaker or fuse box. In one embodiment, the tone generator 810 is configured to be able to generate two or more tones (e.g., 2 MHz, 4 MHz, 6 MHz, etc.) at HF frequencies so that the impedance of power lines in the residence as a result of “skin” effect may be calculated, thereby allowing for measurement of the individual impedances of the appliances on the power circuits to be measured along with estimates of the distance between the appliances and the socket used by the present inventive concept.

A real time clock 812 may be configured to operate on the socket meter 800 so that the processing unit 802 may manage dates and times that measurements are made. In one embodiment, the real time clock 812 may be utilized by the processing unit 802 to verify that certain operations (e.g., reporting collected data to a remote server) occur at specific times of the day. Still yet, the processing unit 802 may utilize the real time clock 812 to timestamp dates and times that certain events occur, such as spikes in resistance from an appliance. In one embodiment, the real time clock 812 may be utilized by the processing unit 802 to cause impedance measurements on a periodic basis (e.g., every second).

A user interface 814 may include push buttons, dials, touch screens, or any other user interface element that enables a user to control, program, access data, or otherwise interface with the socket meter 800. User interface 814, for example, may enable a user to set power usage thresholds that, in the event that a total power usage in the residence exceeds a threshold level, the socket meter 800 may generate a notification in the form of an audible, visible, or message form. For example, in the event that over 100 kW are being utilized at any point in time, the socket meter 800 may be configured to communicate an e-mail or text message to the user for notification purposes. Alternatively, the socket meter 800 may generate an audible sound (e.g. beeping sound) to notify the user that excessive power is being drawn by appliances in the residence.

A power source 816 may be configured to power the other components in the socket meter 800. The power source 816 may be configured to convert 120 volt AC power from a wall socket into which the socket meter 800 is connected into 5 volts DC and AC power for driving the other components in the socket meter 800, including powering the tone generator 810 that generates tone signals in the form of 5 volt, HF frequency signals (e.g., 2 MHz). The power source 816 may alternatively be a battery that is rechargeable or non-rechargeable, as understood in the art.

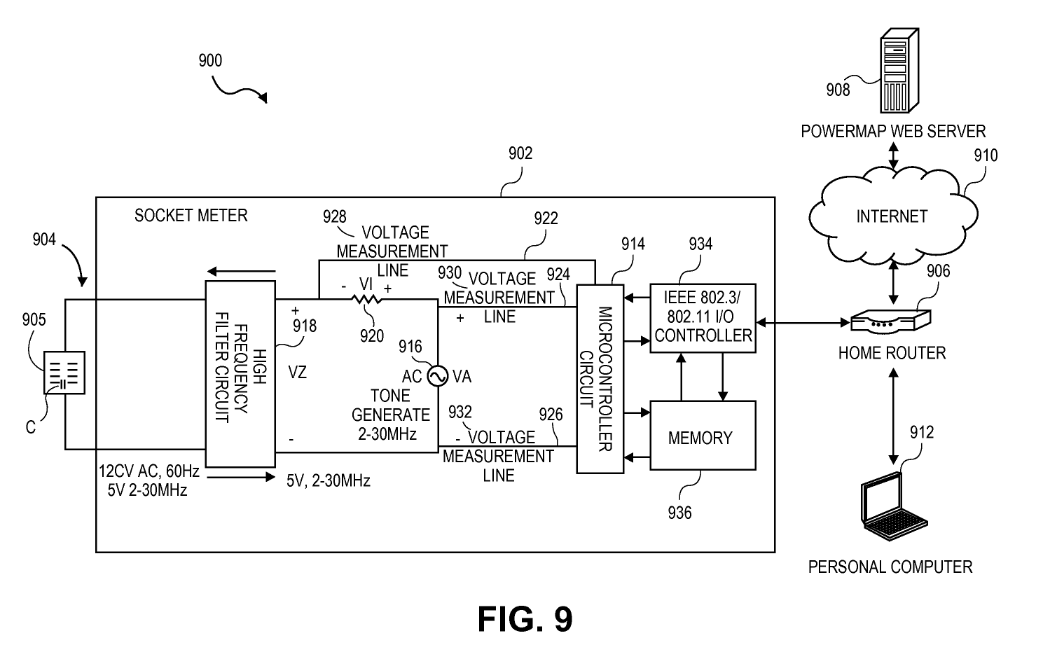

With regard to FIG. 9, an illustration of an illustrative network system 900 including an illustrative socket meter 902 illustrating an internal schematic, and connected to a power circuit 904 that connects to a breaker panel 905 of a residence is illustrated. In one embodiment, the socket meter 902 may be configured to communicate with a home router 906 for communication with a server 908 via the Internet 910 or any other network. The socket meter 902 may alternatively communicate with a mobile telephone communication system for communicating with the server 908. A personal computer 912 may also be in communication with the home router 906 and configured to display a graphical user interface via a web browser, as understood in the art, configured to receive and display data representative of power utilization at the residence as determined by the socket meter 902 and/or server 908.

The socket meter 902 may include a microcontroller circuit 914 that is configured to control operation of the socket meter 902. The microcontroller circuit 914 may be configured to communicate with a tone generator 916 that generates tones between approximately 1 MHz and approximately 30 MHz. The microcontroller circuit 914 may control or select the frequency at which the tone generator is operating, thereby enabling the microcontroller circuit 914 to selectively set a frequency of a measurement signal to measure impedance of appliances operating on the power circuit 904. It should be understood that the power circuit 904 (e.g., power lines in a house) may include multiple circuits or phases that have a capacitance C between the individual circuits. A high frequency filter circuit 918 may be configured to be in parallel with the power circuit 904 to allow high frequencies (e.g., 1 MHz and higher) to be communicated over the power circuit 904 from the socket meter 902 while reducing frequency signals below high frequencies. A resistor 920 may be placed in series with the tone generator 916 and power circuit 904.

In operation, the socket meter 902 is configured to measure three AC voltage levels, including applied voltage produced by the tone generator 916 (VA), voltage across the resistor 920 (VI), and voltage across the unknown impedance on the power circuit 904 (VZ). As previously described with regard to FIGS. 5 and 6, the magnitude of these three voltages may be utilized to determine both resistance and reactance of the unknown impedance of appliances connected in parallel on the power network 904. Lines 922, 924, and 926 may be utilized to provide voltage measurements 928, 930, 932 to the microcontroller circuit 914. The microcontroller circuit 914 may be configured to process the voltage measurements (i.e., measurements of VA, VI, and VZ) and communicate the voltage measurements via an input/output unit 934, which may be an IEEE 802.3/802.11 I/O controller, via the home router 906 and to the server 908 for further processing. In addition to the voltages that are collected and communicated, the socket meter 902 may further be configured to communicate other data, such as timestamp, impedance, power usage, or any other information that the socket meter 902 may generate or measure. The memory 936 may be configured to store data that is collected, generated, and/or processed for utilization by the socket meter 902 or communication to the server 908 for processing thereat. In one embodiment, the personal computer 912 may be configured to communicate directly with the socket meter 902 for programming or setting certain parameters, such as notification signals, power level alerts, or any other configuration parameters. Alternatively, a customer may interact with a website provided by the server 908 to set configuration parameters and the server 908 may perform a setup of the socket meter 902 to communicating the configuration parameters to the socket meter 902.

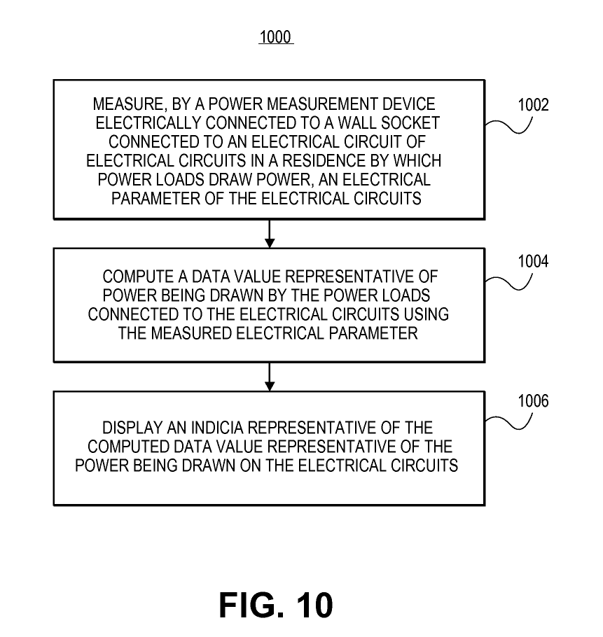

With regard to FIG. 10, a flow chart of an illustrative process 1000 for measuring and processing electrical parameters of electrical circuits to determine power usage is illustrated. The process 1000 starts at step 1002, where a power measurement device electrically connected to a wall socket that is connected to an electrical circuit of multiple electrical circuits in a residence by which power loads draw power may be utilized to measure an electrical parameter of the electrical circuits. In one embodiment, the electrical circuits include electrical wires to which appliances are connected. The electrical parameter may include complex impedance. The complex impedance may be utilized to compute power being drawn by the electrical circuits (i.e., appliances connected to the electrical circuits). As described herein, the multiple electrical circuits may be connected to a circuit breaker and electrically separated by capacitance at the circuit breaker. The power measurement device may be connected to a single power outlet on one of the circuits and measure the electrical parameter as provided the multiple power circuits (e.g., parallel impedance of appliances on two 120 v AC circuits).

At step 1004, a data value representative of power being drawn by the power loads connected to the electrical circuits using the measured electrical parameter may be computed. In computing the data value, measured AC voltages may be utilized to calculate a total complex impedance of complex impedances associated with individual appliances on the electrical circuits. The data value may be a total resistance and/or complex impedance. Alternatively, rather than calculating bulk or total resistance and/or complex impedance, reflectometer measurements may be made and resistance and/or complex impedance may be made on individual appliances. Either coherent or non-coherent measurement techniques may be utilized.

A t step 1006, an indicia representative of the computer data value representative of the power being drawn on the electrical circuits may be displayed. In one embodiment, the indicia may be numbers, such as 82 kW. Alternatively, the indicia may be a graph, chart, or any other indicia capable of representing an amount of power being drawn by appliances on the electrical circuits. It should be understood that multiple indicia representative of multiple data that may be collected and/or computed by the socket meter or server with which the socket may be in communication may be displayed. In one embodiment, the display of the indicia may be on a website accessible by a user via a computing device, text message that may be communicated to a mobile device of a user, e-mail message containing the indicia, or any other form of display, as understood in the art.

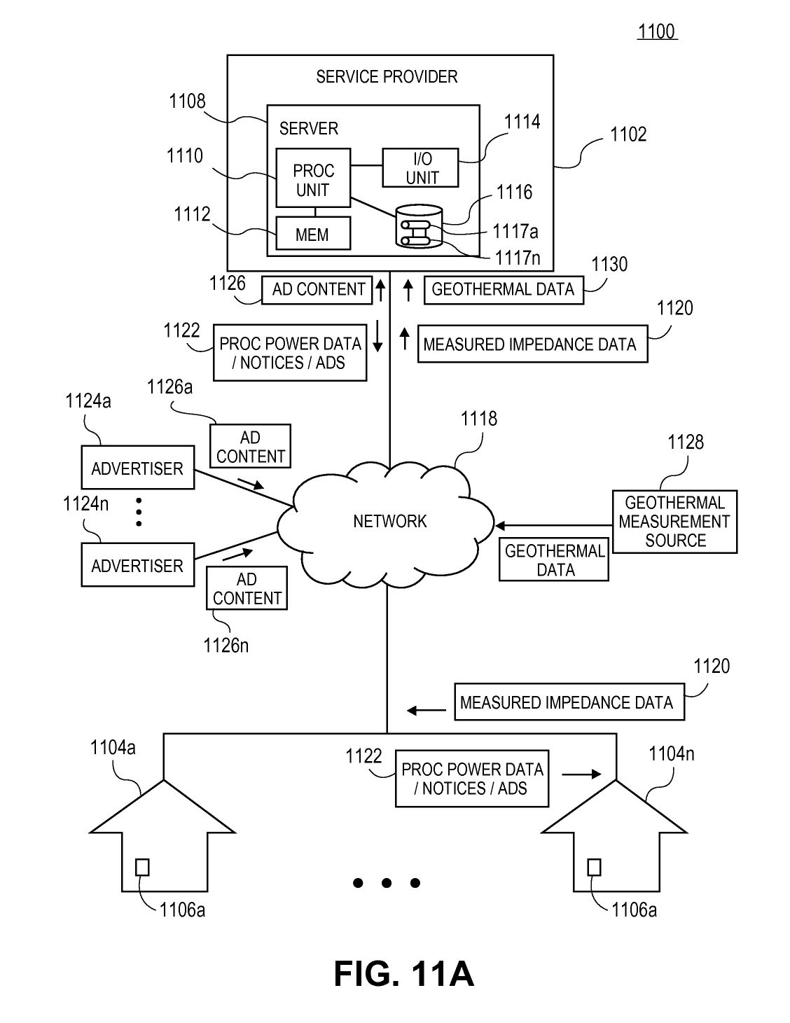

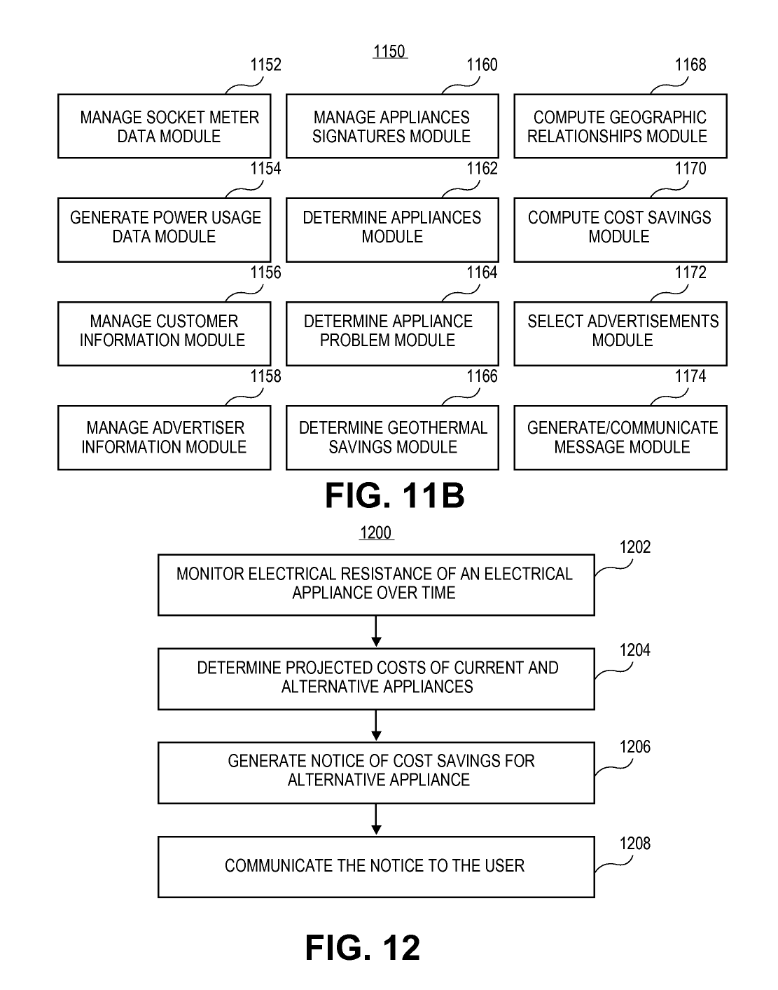

With regard to FIG. 11A, a block diagram of an illustrative network 1100 illustrates a representation of a service provider 1102 that is servicing customers at residences 1104a-1104m (collectively 1104). Each of the residences 1104 includes a socket meter 1106a-1106n (collectively 1106) that is connected to a power circuit within respective residences. The socket meters 1106 may be configured to measure resistance and/or complex impedance of appliances that are being powered by power circuits in the residences. As described herein, the socket meters 1106 may be configured to utilize HF frequencies to measure the complex impedances on multiple power circuits using impedance measurement techniques or reflectometer impedance measurement techniques.

The service provider 1104 may be a power company, third party, or any other service provider that may provide a service of determining power consumption at a residence and deliver advertisements to customers based on power consumption and performance of appliances as measured by the socket meters 1106. The service provider 1102 may operate a server 1108. The server 1108 may have a processing unit 1110 that includes one or more computer processors that executes software (not illustrated) configured to process data received by the socket meters 1106. The processing unit 1110 may be in communication with a memory 1112 that stores software instructions and data collected and/or processed by the processing unit 1100.

The processing unit 1110 may further be in communication with an input/output unit 1114 and storage unit 1116. The I/O unit 1114 may be configured to communicate with the socket meters 1106 via a communications network 1118, such as the Internet. The storage unit 1116 may be configured to store one or more data repositories 1117a-1117n (collectively 1117) that may be configured to store signature data of power usage by specific types, makes, and models of appliances, customer information, advertising information, geothermal information, and any other information in accordance with the principles of the present inventive concept. For example, the customer information may include a history of data, power usage by customers and appliance performance history data that allows the service provider 1102 to track performance of individual appliances of individual customers so that efficiency of the appliances may be tracked. For example, resistance of a washing machine may be tracked over time so that the service provider 1102 may determine when the resistance, which is indicative of inefficiency, of the washing machine increases to the point that the washing machine should be replaced. In addition, if the resistance increases too much or too much over an initial startup phase, then a determination may be made that the washing machine may be becoming a potential fire hazard and the service provider 1102 may generate a notice or alert to the customer of the situation in addition to providing one or more advertisements to the customer of potential replacement washing machines by local or non-local advertisers.

In operation, the socket meter 1106n may measure impedance data 1120 of appliances operating on the power circuits of the residence 1104n and communicate the measured impedance data 1120 via the network 1118 to the service provider server 1108. If the socket meter 1106n calculates power usage based on the impedance data 1120, the power usage data may be communicated to the server 1108 with or without the measured impedance data 1120. The service provider server 1108 may receive the measured impedance data 1120 and process that data to generate processed powered data (e.g., instantaneous power usage, average power usage, wanting total power usage, etc.), notices (e.g., notification that one or more appliances are becoming inefficient or have crossed a threshold level of inefficiency as compared to a new appliance), and advertisements e.g., ads of specific appliances that, as a result of measurements made by the socket meter 1106n. The data 1122 may be communicated back to the socket meter 1106n, display device within the residence 1104n, mobile device of a customer, or webpage of the customer as provided by the server 1108. The data 1122 may be automatically communicated or pushed to the customer or pulled by the customer from the server 1108.

Advertisers 1124a-1124n (collectively 1124) may interact with the service provider 1102 to provide the service provider with advertising information that may be used to deliver notifications of appliances that are available for purchase by customers that have inefficient or broken appliances. The advertisers 1124 may provide the service provider 1102 with address information (not illustrated) and ad content 1126a-1126n (collectively 1126). In one embodiment, the processing unit 1110 may use customer information, including geographic address or location, and determine advertisers that are local to the customer in need of a new appliance. The server 1108 may generate or include one or more advertisements that include information of the advertisers local to the customer in response to determining that an appliance of the customer is becoming inefficient or that the customer may save a certain amount of money over a certain period of time should he or she replace an existing inefficient appliance based on power pricing, appliance power usage, cost of a new appliance, or any other factor.

The principles of the present inventive concept further provide for a geothermal source 1128, such as the U.S. Government, that collects geothermal data 1130, such as sun and wind data, on a regional basis to provide the geothermal data 1130 to the service provider server 1108. the server 1108 may be configured to receive ad content 1126 from advertisers 1124, which may be the same or different from advertisers of appliances, to determine how installing geothermal power sources, such as solar panels or wind turbines, could save a customer money. The determination may be customized based on geographic location of the customer and local suppliers of the geothermal power sources.

In addition to the service provider 1102 collecting and processing data for individual customers in residences 1104a, the principles of the present inventive concept provide for the service provider 1102 to track data in the aggregate. As the service provider 1102 receives data of specific types, makes, and models of appliances, the service provider 1102 may process that data to produce aggregate data that illustrates a variety of parameters, include average duration of time before an appliance make and model becomes inefficient (e.g., greater than 25% inefficient as compared to being new), actual average power usage of specific appliances, and so on. The resulting aggregate data may be used for both commercial and consumer purposes. For example, a manufacturer may desire to determine how its appliances operate in the “field” over time. A manufacturing industry group may desire to access statistics of its manufacturing members for industry trends or other purposes. Consumers may desire to access this information to identify how certain brands and models perform over time. Insurers or warranty companies may desire this aggregate information to set warranties that will be prices correctly and established for a certain duration of time. The aggregate data may be available for purchase or freely available.

With regard to FIG. 1113, a block diagram of an illustrative set of software modules 1150 that may be executed on the processing unit 1110 (FIG. 11A) of the service provider server 1108. The software modules 1150 may be configured to enable the server 1108 to manage and process power usage data, such as appliance impedance data, collected by a socket meter. The software modules 1150 may further be configured to generate and communicate messages to a customer based on a variety of factors, such as geographic distance between the customer and advertiser of an appliance. For instance, the software modules 1150 may selectively organize and display ads to the consumer based on proximity to the consumer to enable the consumer to patronize a seller that is geographically local to the consumer. In this manner, an ad from a seller that is geographically local to the consumer may be listed before an ad from a seller that is not geographically local to the consumer.

A manage socket meter data module 1152 may be configured to manage data that is collected and/or generated by socket meters at residences of customers. The module 1152 may be configured to received and store the data so that other modules may process the data and so that the service provider may access the “raw” data at a later point in time for historical and other purposes.

A generate power usage data module 1154 may be configured to generate power usage data based on data received from socket meters. The module 1154 may, for example, compute instantaneous power usage, average power usage, cumulative power usage during a billing cycle, or any other power usage metrics of which the customer, service provider, advertisers, manufacturers, industry, or any other party may be interested.

A manage customer information module 1156 may be configured to store customer information. The customer information may include name, address, geographic coordinates, demographic, or any other information associated with the customer. Geographic coordinates may be used to determine distance from the customer that advertisers are geographically located so that relevant advertisements for replacement or other appliances may be sent to the customer.

A manage advertiser information module 1158 may be configured to manage information associated with advertisers. The information may include physical address information, contact information, website information, geographic coordinate information, and any other information. In addition, the module 1158 may be configured to manage advertisements of appliances associated with advertisers. In one embodiment, the advertisements may include appliances information, current pricing of the appliances, electrical performance of the appliances, physical configuration of the applications, and so forth. The information associated with the appliances, such as pricing, may be used in determining whether the appliance would save the customer money in replacing an inefficient appliance. In one embodiment, rather than advertising appliances, the advertiser may be an advertiser of geothermal devices that use replenishable sources of energy, such as solar.

A manage appliances signatures module 1160 may be configured to manage power usage signatures of types, makes, and models of appliances. In managing the power usage signatures, the module 1160 may be configured to store the signatures in a data repository, such as a database, in an organized manner. For example, the data repository may be configured to store the signatures by appliance type, appliance make (manufacturer), appliance model, or any other configuration. The signatures may be used for identifying the type of appliance that is drawing power. A signature may be a waveform. Alternatively, the signature may be data representative of complex impedance.

A determine appliances module 1162 may be configured to specifically identify appliance type, make, and/or model. The identification of the specific appliances that are being measured at a residence may use a variety of pattern matching or comparison techniques. For example, the same, analogous, or modified comparison techniques may be used to determine appliances as used in speech recognition. In one embodiment, pattern matching to power usage signatures may be utilized. Alternatively and/or additionally, complex impedance matching may be performed. It should be understood that a variety of identification techniques may be utilized in accordance with the principles of the present inventive concept. As an alternative to automatically identify appliances using power usage signature matching, the customer may provide a list of appliances at the customer's residence and the determine appliances module 1162 may simply look-up the signature.

A determine appliance problem module 1164 may be configured to determine an appliance problem with appliances on the power circuit network at a residence of the customer by comparing specification operating parameters as defined by a signature or other specifications, as understood in the art. The module 1164 may be configured to determine a number of parameters, including operating performance, inefficiency, potential fire hazard, and other problems. In response to determining that a problem exists, the module 1164 may update a data repository or notify another module directly to cause a notification, alert, or alarm to be generated to notify the customer.

A determine geothermal savings module 1166 may be configured to access geothermal information accessible by the server 1108 that provides for geothermal information in a geographic area in which a customer resides. The module 1166, based on an amount of energy used to heat or cool the residence of the customer, may determine how much money the customer could save by installing a geothermal energy production device, such as solar panels. The cost savings may include cost of the geothermal energy production device, installation costs, and cost savings. In addition, the cost of electricity being paid by the customer may be factored into the calculations.

A compute geographic relationships module 1168 may be configured to compute a distance between a customer and advertisers of appliances. If the customer desires to receive advertisements from local advertisers, then a distance from the customer's residence to a store of the advertiser may be computed to determine whether the advertiser is local. The module 1168 may itself perform the distance calculation or the module 1168 may invoke a distance calculation system (e.g., MapQuest® mapping system) remotely located from the server 1108.

A compute cost savings module 1170 may be configured to use power usage information of an appliance and determine whether the customer would save money over time (e.g., 1 year) by replacing the appliance with an energy efficient appliance. In determining the cost savings, the module 1170 may use the current energy pricing (e.g., $0.12/kWh) and compare to actual power usage of the appliance with specifications of the new appliance.

A select advertisements module 1172 may be configured to select particular advertisement(s) to present to a customer depending on whether the customer can save money over a certain time period (e.g., 3 years) by replacing an existing energy inefficient appliance. In addition, if it is determined that an existing appliance is becoming a fire hazard, an advertisement from an advertiser may be selected and sent to the customer. In one embodiment, the advertisements may be local to the customer. The advertisements may be of appliances that are the same or equivalent makes and models to the appliance that is energy inefficient. A variety of factors may be used, including using the customer's profile, to select how many and which advertisements are to be sent. The module 1172 may select repair advertisements if it is deemed that the appliance, such as a washing machine, could be fixed or adjusted to correct for energy inefficiency.

A generate/communicate message module 1174 may be utilized to generate and communicate messages. In one embodiment, the messages may include advertisements. The messages may provide for real-time, up-to-date, or current monthly total power usage. The messages may further include information about specific appliances, such as “Your refrigerator is now 30% below original energy usage efficiency.” The messages may also include alerts, such as “There is a potential fire hazard with your air conditioner.” The messages may be posted to a website or a widget for the customer, communicated over a communications network (e.g., email, text message), mailed, placed over a telephone line, or any other means for communicating information to the customer. In another embodiment, a mobile device application may be used to enable the customer to receive or request up-to-date power usage or other information in accordance with the principles of the present inventive concept.

It should be understood that the modules 1150 are illustrative and that alternative and/or additional modules may be utilized in accordance with the principles of the present inventive concept. Still yet, the modules 1150 may be combined or segmented into distinct modules to provide for functionality as described herein.

With regard to FIG. 12, a flow diagram of an illustrative process 1200 for monitoring power usage by measuring resistance of appliances at a residence and communicating a notice to the customer is illustrated. The process 1200 starts at step 1202, where electrical resistance of an electrical appliance may be monitored over time. The electrical resistance may be a real part of a complex impedance measured of an appliance. In one embodiment, the measurement may be performed using bulk impedance measurements, either coherent or non-coherent, or reflectometer techniques, either coherent or non-coherent, to measure individual appliances on the power circuit network as understood in the art. The measurements may be made utilizing HF frequencies, as previously described herein. As step 1204, projected costs of current or existing and alternative appliances may be determined. The projected costs may be based on current power usage by each of the appliances based on resistance of the appliances. The determination of the projected cost may be projected out one or more years to determine how much more energy an existing, inefficient appliance will use over a new appliance. In one embodiment, the new appliance may be the same make and model. However, it should be understood that the principles of the present inventive concept provide for determining a difference in energy usage over time of an existing appliance being utilized by a customer versus a new, efficient appliance.

At step 1206, a notice of cost savings for an alternative appliance may be generated. The notice of cost savings may include a cost savings over time (e.g., three years), where the cost savings may be at or above a certain threshold level based on a customer's desire for receiving a notice before the notice is to be sent. At step 1208, the notice may be communicated to the user. The notice may be in the form of posting on a webpage or sending an electronic message to the customer. Still yet, the notice may be in the form of a telephone call that presents a synthesized or actual person's voice to the customer to notify the customer of the potential cost savings should the customer replace the inefficient appliance with an efficient appliance.

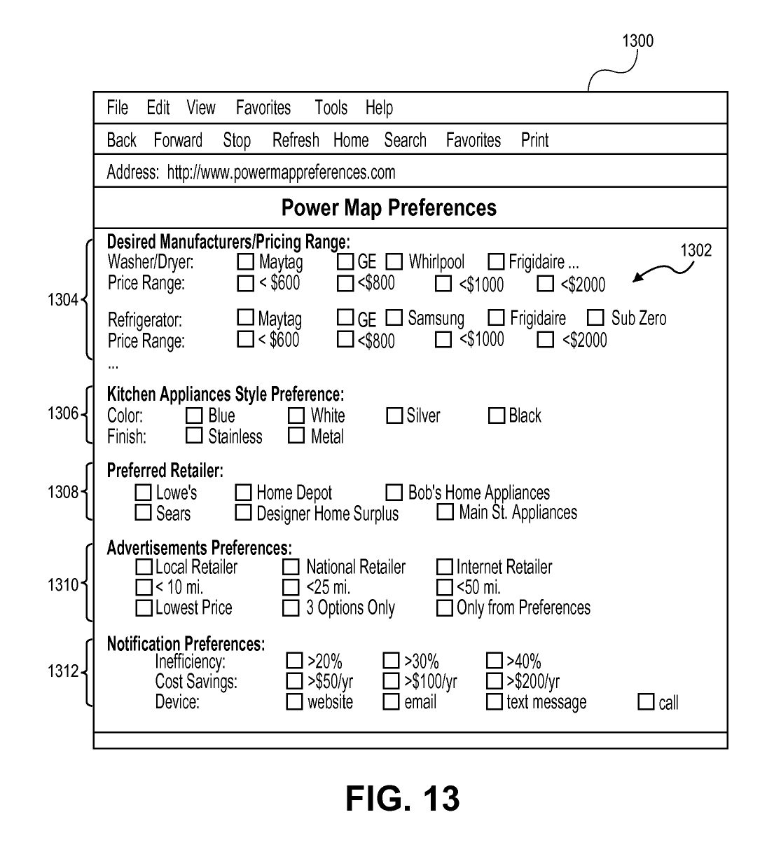

With regard to FIG. 13, a screen shot of an illustrative browser interface 1300 illustrates an illustrative website 1302 that enables a customer of a service provider to submit preferences for the service provider to provide advertisements to the customer in response to determining that an appliance may need to be repaired based on becoming inefficient or newer appliances may save the customer money over time due to being more efficient in using less power. The website 1302 may include a desired manufacturers price range section 1304 in which a customer may select desired manufacturer(s) and price range of specific appliances (e.g., washer/dryer, refrigerator, etc.). The manufacturers may be brand name manufacturers and the price ranges may be low cost appliances up to expensive appliances within each appliance type. A kitchen appliance style preference section 1306 allows a customer to select kitchen appliance style, including color and finish. A preferred retailer section 1308 allows a customer to select preferred retailer(s) from which the customer desires to receive advertisements in the event that the service provider determines that an appliance of the customer is inefficient or other appliances may allow the customer to save money through power usage savings.

An advertisements preferences section 1310 may enable a customer to select advertisement options, which may include local retailers, national retailers, Internet retailers, retailers that are within 10 miles of his or her residence, within 25 miles of his or residence, within 50 miles of his or her residence, lowest priced appliance, three options only of an appliance for replacement, only advertisements that meet the preferences selected by the customer. A notification preference section 1312 may allow a customer to select notification options, where the notification options or preferences may include inefficiency or cost savings options. In one embodiment, the cost savings may be on an annual basis. Alternatively, the cost savings may be on a multi-year basis. Still yet, the cost savings may be computed based on replacement cost of the appliance plus power usage costs for using the newer appliance. For example, if an existing appliance is to cost $1200 over the next three years of power usage and a new appliance costs $500 and the customer will only use $500 of energy based on the new appliance being more energy efficient, the cost savings will be $200 over the next three years. The notification preferences may also include notification devices to which the notices and/or alerts are to be communicated to the customer.

It should be understood that the website 1302 is illustrative in that each of the sections and selectable options within the sections may be different than those illustrated herein. It should further be understood that alternative options and preferences may be provided to the customer for selection of how the customer is to be notified what content is to be delivered to the customer in the notifications, power usage data that is to be computed and reported, or any other information in accordance with the principles of the present inventive concept.

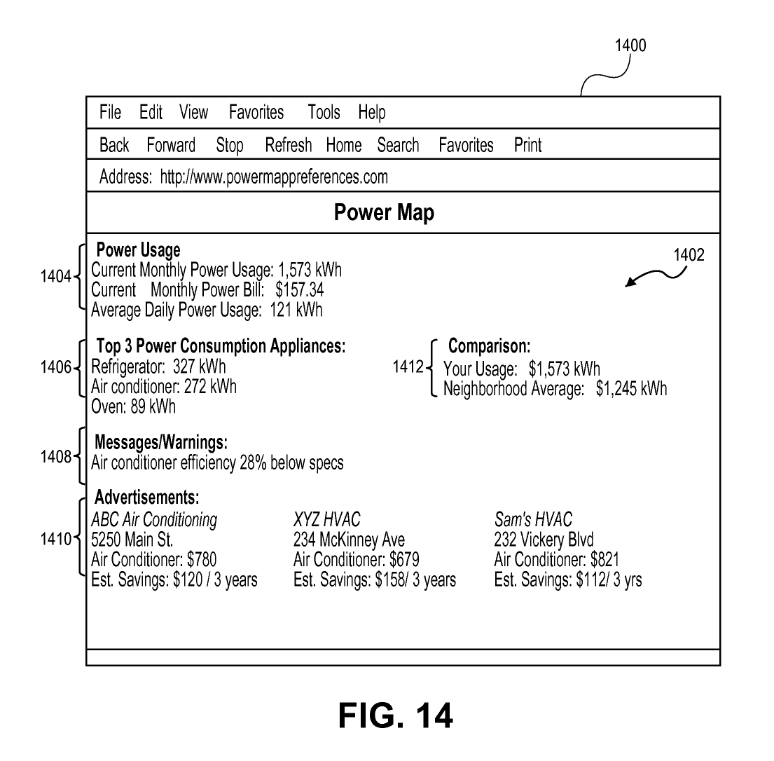

With regard to FIG. 14, a screenshot of an illustrative browser interface 1400 is illustrated to include an illustrative webpage including power usage information, messages/warnings, and advertisements for a customer to view. The webpage 1402 may include a power usage section 1404 that displays current monthly power usage, current monthly power bill, and average daily power usage. Other power usage data may be provided to the customer. A top three power consumption appliances section 1406 may present the top three power consumption appliances in a residence of the customer. For example, as illustrated, a refrigerator has currently consumed 327 kWh during the month, air conditioner has consumed 272 kWh during the month, and oven has consumed 89 kWh during the month. By providing the top three power consumption appliances, the customer may become sensitive to efficiency of these appliances or usage of optional appliances (e.g., hair dryers). A messages/warnings section 1408 may provide a message of inefficiency or otherwise to a customer. For example, in the event that an air conditioner is becoming inefficient, a message may be displayed that the air conditioner is a certain percentage of efficiency below its original specs.

An advertisements section 1410 may be configured to display advertisements from advertisers that sell appliances that are becoming inefficient or can provide cost savings for the customer over a certain time period. As illustrated, three advertisements are provided from local, national, and/or Internet sellers of air conditioners. In addition, the advertisements may list prices of a new air conditioner that may be the same make and model or different make and model than that currently owned by the customer and estimated cost savings over a certain time period (e.g., three years). The advertisements may be selectable to enable a user to automatically be linked to the advertiser's website to view the specific air conditioner available for sale and purchase the air conditioner from the advertiser either via the website and/or provide contact information for the advertiser to enable the customer to determine location of the advertiser for visiting the retail store of the advertiser.

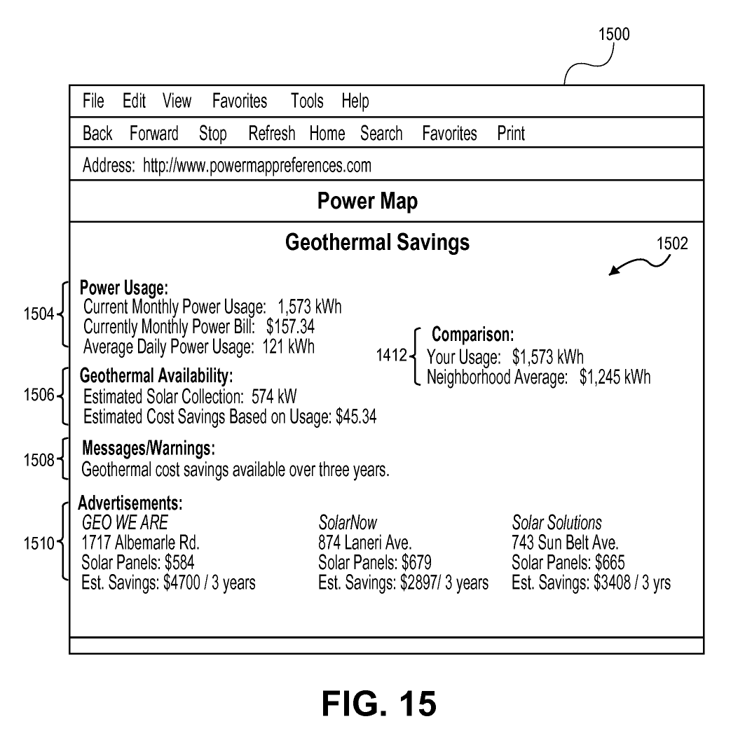

With regard to FIG. 15, a screenshot of an illustrative browser interface 1500 is illustrated to include an illustrative webpage including power usage information, geothermal availability, messages/warnings, and advertisements for a customer to view. The webpage 1502 may include a power usage section 1504 that displays current monthly power usage, current monthly power bill, and average daily power usage. Other power usage data may be provided to the customer. A geothermal availability section 1506 may present the customer with power and cost savings if geothermal devices are installed at the residence of the customer. For example, if solar collection were installed, 574 kW could be collected and a cost savings of $45.34 is estimated to occur. A messages/warnings section 1508 may provide a message of inefficiency or otherwise to a customer.

An advertisements section 1510 may be configured to display advertisements from advertisers that sell appliances that are becoming inefficient or can provide cost savings for the customer over a certain time period. As illustrated, three advertisements are illustrated from local advertisers. It should be understood that advertisements from national and/or Internet sellers of solar panels may be provided, as well, depending on customer preferences. In addition, the advertisements may list prices of new solar panels may be provided. In addition, estimated cost savings of the solar panels may be illustrated. It should be understood that alternative geothermal devices that can help a customer save money may also be available for presenting advertisements to a customer. The advertisements may be selectable to enable a user to automatically be linked to the advertiser's website to view the specific solar panels available for sale and purchase the solar panel from the advertiser either via the website or enable the customer to determine location of the advertiser for visiting the retail store of the advertiser. Various embodiments of the present inventive concept can be embodied as computer readable codes on a computer readable recording medium. The computer readable recording medium may include any data storage device suitable to store data that can be read by a computer system. A non-exhaustive list of possible examples of computer readable recording mediums include read-only memory (ROM), random-access memory (RAM), CD-ROMS, magnetic tapes, floppy disks, optical storage devices, and carrier waves, such as data transmission via the Internet. The computer readable recording medium may also be distributed over network-coupled computer systems so that the computer readable code is stored and executed in a distribution fashion. Various embodiments of the present inventive concept may also be embodied in hardware, software or in a combination of hardware and software. For example, the processing unit 802, memory 808, user interface 814, and browser interface 1300, 1400, 1500, and/or functions thereof may be embodied in software, in hardware or in a combination thereof. In various embodiments, the processing unit 802, memory 808, user interface 814, and browser interface 1300, 1400, 1500 and/or functions thereof may be embodied as computer readable codes on a computer readable recording medium to perform tasks such as file and/or data transmission and/or reception operations, such as those illustrated in FIGS. 8-12. Further, the processing unit 802, memory 808, user interface 814, and browser interface 1300, 1400, 1500 and/or functions thereof may be embodied as computer readable codes on a computer readable recording medium to perform tasks such as displaying and/or printing operations, such as the data displaying and printing operations illustrated in FIGS. 13-15.

The previous detailed description is of a small number of embodiments for implementing the invention and is not intended to be limiting in scope. One of skill in this art will immediately envisage the methods and variations used to implement this invention in other areas than those described in detail.

Having now described the features, discoveries and principles of the present inventive concept, the manner in which the present inventive concept is constructed and used, the characteristics of the construction, and advantageous, new and useful results obtained; the new and useful structures, devices, elements, arrangements, parts and combinations, are set forth in the appended claims.

It is to be understood that the following claims are intended to cover all of the generic and specific features of the present inventive concept herein described, and all statements of the scope of the present inventive concept which, as a matter of language, might be said to fall therebetween.

What is claimed:

1. A method to measure power usage within a network having a plurality of electrical circuits electrically connected to an over-current protection device, said method comprising:
measuring, by a power measurement device electrically connected to one or more of the electrical circuits by which power loads draw power, an electrical parameter of the electrical circuits;
computing a data value representative of power being drawn by the power loads connected to the electrical circuits using the measured electrical parameter; and
displaying an indicia representative of the computed data value representative of the power being drawn on the electrical circuits.

2. The method according to claim 1, wherein measuring includes:
generating a measurement signal at a frequency above a threshold frequency that, when the measurement signal is communicated on the electrical circuit, passes through an electrical component at the overcurrent protection device that is electrically positioned between two of the electrical circuits to another of the electrical circuits; and
communicating the measurement signal on the electrical circuit.

3. The method according to claim 2, wherein generating the measurement signal includes generating the measurement signal between approximately 1 MHz and approximately 30 MHz.

4. The method according to claim 1, further comprising:
communicating the calculated data value representative of the power being drawn to a remote location from the power measurement device;
storing the calculated data value at the remote location;
processing the calculated data value to generate at least one statistic; and
enabling a user to access the calculated data value and generated at least one statistic.

5. The method according to claim 1, wherein measuring includes measuring complex impedance on the electrical circuits, the complex impedance including both real and imaginary parts.

6. The method according to claim 1, wherein measuring is performed using a non-coherent measurement technique.

7. The method according to claim 1, wherein measuring is performed using a coherent measurement technique.

8. The method according to claim 1, wherein measuring includes:
communicating a first pulse having a first frequency over the electrical circuit;
measuring a first reflectance signal of the first pulse from each load or discontinuity;
communicating a second pulse having a second frequency over the electrical circuit; and
measuring a second reflectance signal of the second pulse from each load or discontinuity.

9. The method according to claim 1, further comprising:
determining resistance of a load on the network;
determining that the resistance of the load is at or above a threshold resistance value; and
notifying a user that the resistance of the load has crossed the threshold resistance value.

10. The method according to claim 9, further comprising:
communicating at least one load replacement option to the user.

11. The method according to claim 1, wherein measuring includes measuring complex impedance on the electrical circuits, the complex impedance measured by using an auto balancing bridge circuit, a resonant (Q-adapter/Q-Meter), RF I-V (current-voltage) measurement techniques, network analysis (reflection coefficient) or TDR (Time Domain Reflectometry) complex impedance meter circuit.

12. The method according to claim 1, wherein measuring includes measuring complex impedance on the electrical circuits, the measured complex impedance decomposed into components which represent individual impedances of appliances which load the network, the decomposition obtained via a network circuit model of the network with resistors, capacitors, and inductors in parallel and series combinations connected by wires with a frequency dependence given by the Skin Effect, the network circuit model having parameters defined by numeric optimization using the measured complex impedance of the network at different frequencies to determine optimum circuit values, and the power usage within the network is determined by converting the network and individual impedances using P=V²/R where V is measured about its nominal of 120 volts.

13. The method according to claim 1, further comprising:
a phase coupler to measure one or more phases of a power network with frequencies at or below 1 MHz.

14. The method according to claim 13, wherein the phase coupler includes a high precision impedance converter system having a frequency generator with an analog-to-digital converter and wireless communication i/o interface.

15. A device to measure power usage within a residence having a plurality of electrical circuits electrically connected to an over-current protection device, said method comprising:
a first circuit configured to generate an alternating current (AC) measurement signal;
a second circuit configured to apply the AC measurement signal onto one of the electrical circuits;
a third circuit configured to measure a plurality of AC voltages in response to said second circuit applying the AC measurement signal onto one of the electrical circuits;
a processing unit in communication with said third circuit, and configured to calculate an impedance of appliances connected to the electrical circuits; and
an input/output unit in communication with said processing unit and configured to communicate data generated by said processing unit to a remote location via a communications network.

16. The device according to claim 15, wherein said processing unit is further configured to calculate power usage based on the calculated impedance of the appliances connected to the electrical circuits.

17. The device according to claim 15, wherein the alternating current measurement signal is above approximately 1 MHz.

18. The device according to claim 15, wherein said second circuit includes a high-frequency filter.

19. The device according to claim 15, wherein said third circuit includes a resistor in series with said first circuit.

20. The device according to claim 15, wherein the AC measurement signal has an amplitude at or below approximately 5 volts.

21. The device according to claim 15, wherein said third circuit is configured to measure an applied voltage (VA), voltage across a known resistor (VI), and a voltage across an unknown impedance (VZ), where the voltages are AC voltages.

22. The device according to claim 21, where said processing unit is configured to calculate the impedance of the appliances connected to the electrical circuits based on the measured VA, VI, and VZ AC voltages.

23. The device according to claim 15, wherein said first circuit, second circuit, third circuit, and processing unit are configured to use non-coherent measurement techniques.

24. The device according to claim 15, wherein said first circuit, second circuit, third circuit, and processing unit are configured to use reflectometer measurement techniques to measure impedance of individual appliances drawing power from one of the electrical circuits.

25. The device according to claim 15, wherein said processing unit is further configured to generate a notification in the event that a determination is made in which the amount of power being drawn has crossed a voltage threshold level.

26. The device according to claim 15, further comprising an electronic display in communication with said processing unit, said processing unit configured to display an indicia representative of power usage of the appliances on the power circuits.

27. A method to advertise electrical appliances to potential customers, said method comprising:
monitoring electrical resistance of an electrical appliance over time;
determining that a projected cost to utilize the electrical appliance over a projected time period based on the monitored electrical resistance will exceed a projected cost to utilize a replacement electrical appliance over the projected time period;
generating a notice that indicates that a user of the electrical appliance will save money by replacing the electrical appliance with the replacement electrical appliance over the projected time period, the notice further including a listing of the replacement electrical appliance available for purchase; and
communicating the notice to the user.

28. The method according to claim 27, wherein communicating the notice to the user includes posting the notice on a website for the user to access.

29. The method according to claim 27, further comprising:
determining that the projected cost will exceed a predetermined threshold dollar value.

30. The method according to claim 27, further comprising:
determining that the electrical resistance of the electrical appliance has crossed an electrical resistance threshold level;
generating a second notice that indicates that the electrical appliance has crossed the electrical threshold level; and
communicating the second notice to the user.

31. The method according to claim 27, further comprising:
determining that a rate of increase of the electrical resistance of the electrical appliance increases faster than a threshold rate;
generating a second notice that indicates that the electrical appliance has become hazardous; and
communicating the second notice to the user.

32. The method according to claim 27, further comprising:
measuring electrical characteristics of the electrical appliance;
determining a brand and model of the electrical appliance based on measuring electrical characteristics or user input;
determining other electrical appliances that are ideal replacement electrical appliances for the electrical appliance based on the determined brand and model of the electrical appliance; and
selecting at least one of the ideal replacement electrical appliances for inclusion in the notice.

33. The method according to claim 32, further comprising:
determining geographical location of the electrical appliance; and
wherein determining other electrical appliance that are deemed to be ideal replacement electrical appliances for the electrical appliance includes determining a local retailer that carries at least one of the other electrical appliances that is local to the geographical location.

34. The method according to claim 27, wherein generating the notice includes generating an advertisement that includes the listing of the replacement electrical appliance, the advertisement including a name of a retailer that carries the replacement electrical appliance.

35. The method according to claim 27, wherein generating the notice includes generating the notice in response to determining that the user will save money over the projected time period of 3 years.
